(19) United States
(12) Patent Application Publication
(10) Pub. No.: US 2007/0282710 A1
(43) Pub. Date: Dec. 6, 2007

(54) METHOD FOR DEMONSTRATING THE FEATURES OF AN APPLICATION PROGRAM

(75) Inventors: Michele K. Lim, Sunrise, FL (US); Normarie Garcia, Plantation, FL (US); Donald J. Phelps, Weston, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/420,439

(22) Filed: May 25, 2006

(51) Int. Cl. G06Q 30/00

(52) U.S. Cl. 705/27

(57) ABSTRACT

A method for demonstrating one or more features (106) of an application program (104) to a user of a data processing unit (DPU) (102) provides an improved user interface for the DPU. The method includes displaying (204) the one or more features, which can include free-to-use (410) and price-based features (412). The method also includes detecting (206) the selection of a feature from the one or more features. Moreover, the method includes enabling access (208) to the feature and also disabling (210) the configuration of a price-based feature.

### FIELD OF THE INVENTION

The present invention relates to the field of application programs running on Data Processing Units (DPUs), and in particular to a method for demonstrating the features of an application program to a user of a DPU.

### BACKGROUND OF THE INVENTION

With the advent of technology, the use of Data Processing Units (DPUs) such as computers, laptops, smart phones, mobile phones, and Personal Digital Assistants (PDAs) has become common. DPUs can run various application programs, such as text editors, media players, and software for emails to name a few. Various features can be associated with the application program. These features may be free-to-use or price-based features. A user of a DPU can freely utilize the free-to-use features, whereas utilization of the price-based features can be restricted. The price-based features may have to be bought by the user before being configured on the DPU. For example, in an application known as MATLAB®, features such as integer and single-precision mathematics, ODE (Ordinary Differential Equations) solver functionality, and automatic program code publishing are classified as free-to-use features, whereas features such as GARCH (Generalized Autoregressive Conditional Heteroskedasticity) toolbox, optimization toolbox, and statistics toolbox are classified as the price-based features.

Due to the inclusion of numerous features in an application program, it has become difficult to inform and educate users about all the features and associated functionalities. The users may spend a considerable amount of time and energy exploring features, trying to understand each feature's associated functionality. Due to the lack of awareness among the users about the features, the providers of application programs can miss opportunities to sell the price-based features.

Nowadays, the features of an application program are advertised to the users through non-interactive means, such as by displaying screenshots containing information about the utility of the features or how to configure the features. However, many users may still find it difficult to understand the utility and correct functionalities associated with each feature. Users who misunderstand the utility of the features may end up purchasing the wrong features. Further, users, who do not understand how to correctly configure features, may become frustrated with the DPU product.

In light of the foregoing discussion, there is a need for a method that can quickly and correctly educate users about the features of an application program.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 represents an exemplary Data Processing Unit (DPU), in accordance with an embodiment of the present invention;

FIG. 2 is a flow chart illustrating a method for demonstrating one or more features of an application program, in accordance with an embodiment of the present invention;

FIG. 3 is flowchart illustrating a method for demonstrating one or more features of an application program, in accordance with another embodiment of the present invention.

FIG. 4 represents an exemplary screenshot for displaying one or more features of an application program, in accordance with an embodiment of the present invention;

FIG. 5 represents an exemplary feature report of an application program, in accordance with an embodiment of the present invention; and

FIG. 6 represents an exemplary screenshot of a multimedia demonstration of an application program, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of embodiments of the present invention.

### DETAILED DESCRIPTION OF THE PREFERRED EMBODIMENTS

Before describing in detail the particular method for demonstrating the features to a user, in accordance with various embodiments of the present invention, it should be observed that the present invention resides primarily in combinations of method steps related to the method for demonstrating the features of an application program to a user of a Data Processing Unit (DPU). Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

In an embodiment, a method is provided for demonstrating one or more features of an application program to a user of a Data Processing Unit (DPU). These features are associated with the application program running on the DPU. The method includes displaying the features that includes free-to-use features and price-based features. The method also includes detecting the selection of at least one feature from the features. The feature is selected by the user. Moreover, the method includes enabling access to the at least one feature, without enabling the configuration of the at least one feature if it is a price-based feature. Thus, access is allowed to both the free-to-use feature and the price-based features, but the price-based features will ultimately not be configured in the end-unit if the application is one that is used to configure an end-unit (for example, a two-way radio) or the price-based feature will ultimately time-out if the feature is a usability feature with the application, such as a GARCH toolbox feature

In another embodiment, a method is provided for demonstrating one or more features of an application program to a user of a DPU. These features are associated with the application program running on the DPU. The method includes displaying the features, and also includes detecting the selection of a feature, the feature being selected by the user. The method also includes at least one of: visually indicating the parameters associated with the feature, launching the configuration screens to configure the parameters, demonstrating the feature, generating a feature report of the feature, displaying customer feedbacks associated with the feature, and accessing the feature while the user is interacting with the application program.

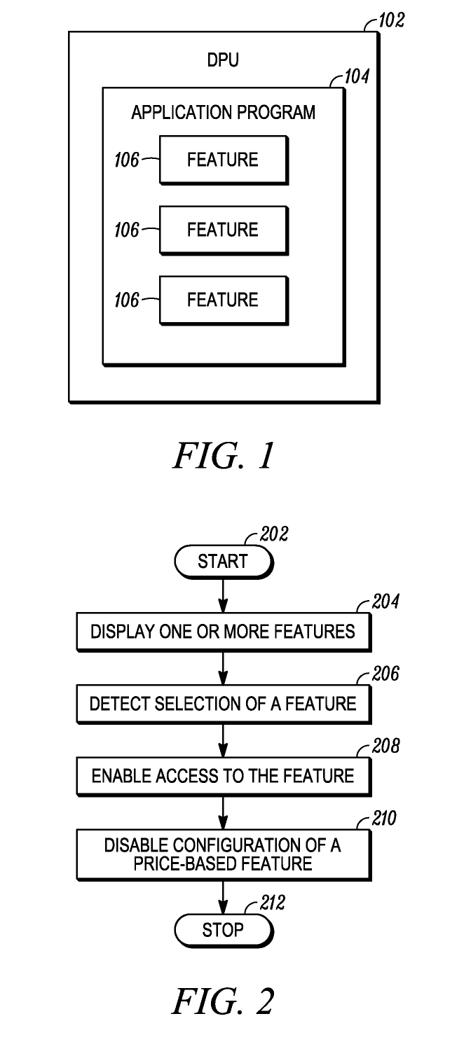

FIG. 1 is an exemplary DPU 102, in accordance with an embodiment of the present invention. The DPU 102 includes an application program 104. Examples of a DPU include, but are not limited to, a computer, a laptop, a smart phone, a mobile phone, and a Personal Digital Assistant (PDA). The application program 104 can be software or computer code that runs on the DPU 102. Examples of the application program 104 include MATLAB®, Microsoft® Word, and Microsoft® Outlook, and so forth. The application program 104 can be associated with an electronic device such as a two-way radio, a PDA, or a mobile phone. The application program 104 can be used to configure or modify the functionalities of the electronic device. These functionalities can be configured or modified by one or more features 106 in the application program 104. For example, a two-way radio can be configured through software including features such as a display option. When the display option is turned ‘ON’, an identification of the communication channel, on which the two-way radio is configured to communicate, can be displayed on the display of the two-way radio. In accordance with the present invention, the DPU 102 provides an improved user interface by allowing users to test drive features prior to purchase. Thus, a well informed consumer can select features suitable to specific needs.

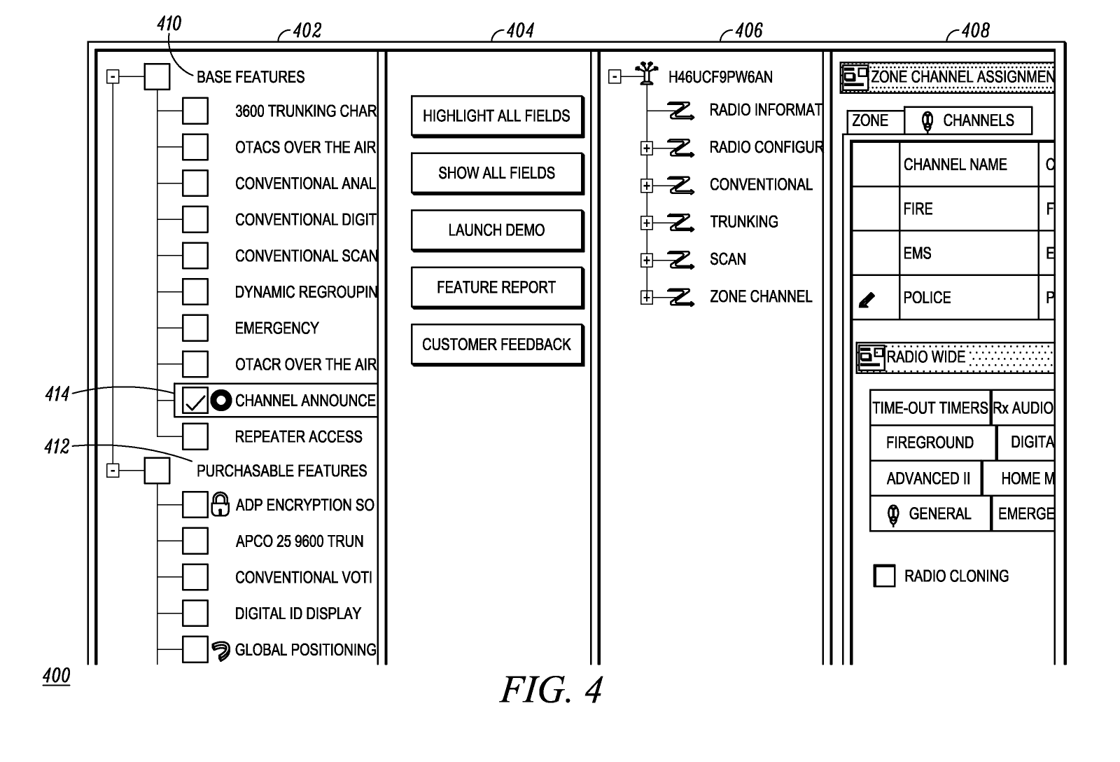

FIG. 2 is a flowchart illustrating a method for demonstrating the one or more features 106 of the application program 104 to a user of the DPU 102, in accordance with an embodiment of the present invention. The method is initiated at step 202. The one or more features 106 are displayed to the user at step 204. The display of the features 106 is explained in further detail in conjunction with FIG. 4. The one or more features 106 can be free-to-use or price-based features. At step 206, the selection of a feature from the one or more features 106 is detected. The feature is selected by the user. It should be noted that a plurality of features can also be selected by the user. Further, access to the feature is enabled at step 208 while the user is interacting with the application program 104. Thereafter, the configuration of the feature is disabled at step 210 if it is a price-based feature, after which the method terminates at step 212.

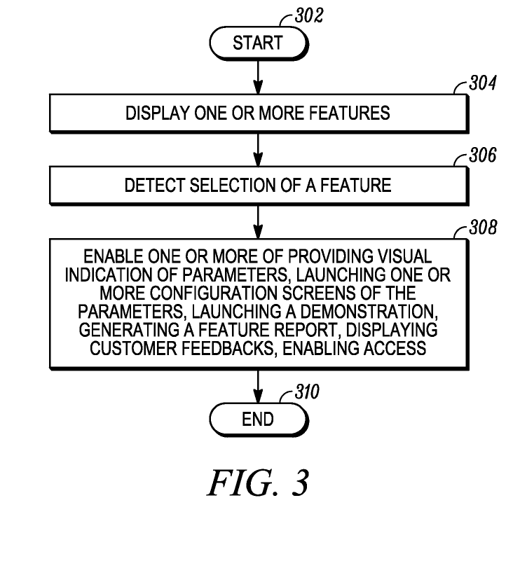

FIG. 3 is a flowchart illustrating a method for demonstrating the one or more features 106 of the application program 104 to a user of the DPU 102, in accordance with another embodiment of the present invention. The method is initiated at step 302. At step 304, the one or more features 106 are displayed to the user. The display of the one or more features 106 is explained in further detail in conjunction with FIG. 4. The one or more features 106 can be free-to-use or price-based features. At step 306, the selection of a feature by the user is detected. It should be noted that a plurality of features can also be selected by the user. Thereafter, at step 308, a visual indication can be provided, configuration screens or a demonstration can be launched, a feature report can be generated, customer feedback can be displayed, and/or the feature can be accessed while the user is interacting with the application program 104.

The visual indication of the feature can be provided by assigning a particular color-scheme based on an input from the user. For example, when a user selects a feature, the parameters associated with that feature are displayed in a particular color so as to make the selected feature noticeable to the user. In an embodiment of the present invention, the parameters can be visually indicated by displaying icons. For example, when a user selects a feature, a set of icons is displayed along with the parameters of the feature. The color-scheme and the icons can be selected from one or more libraries containing various color-schemes and icons.

The configuration screens associated with a parameter can be launched by clicking on an icon associated with the parameter. The configuration screens can be used to configure the parameters associated with the feature. For example, a configuration screen, displaying various communication channels, can be displayed when a user selects an icon associated with a channel parameter. The configuration screens are explained in further detail in conjunction with FIG. 4.

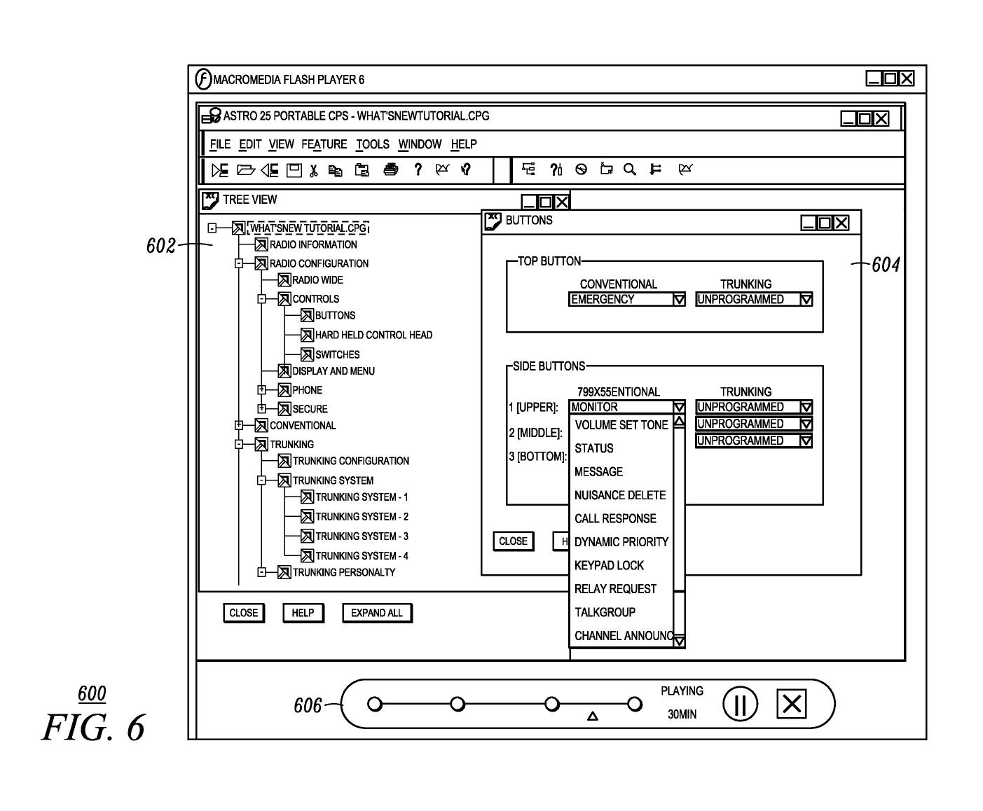

The demonstration of the feature or the parameter can be launched by clicking on the icon associated with the feature or the parameter respectively. The demonstration can be an audio demonstration, a video demonstration and/or a multimedia demonstration. The demonstration can interactively illustrate an explanation of the feature or the parameter, a procedure to use the feature, and/or instructions to configure the parameter or the feature. The demonstration is explained in further detail in conjunction with FIG. 6.

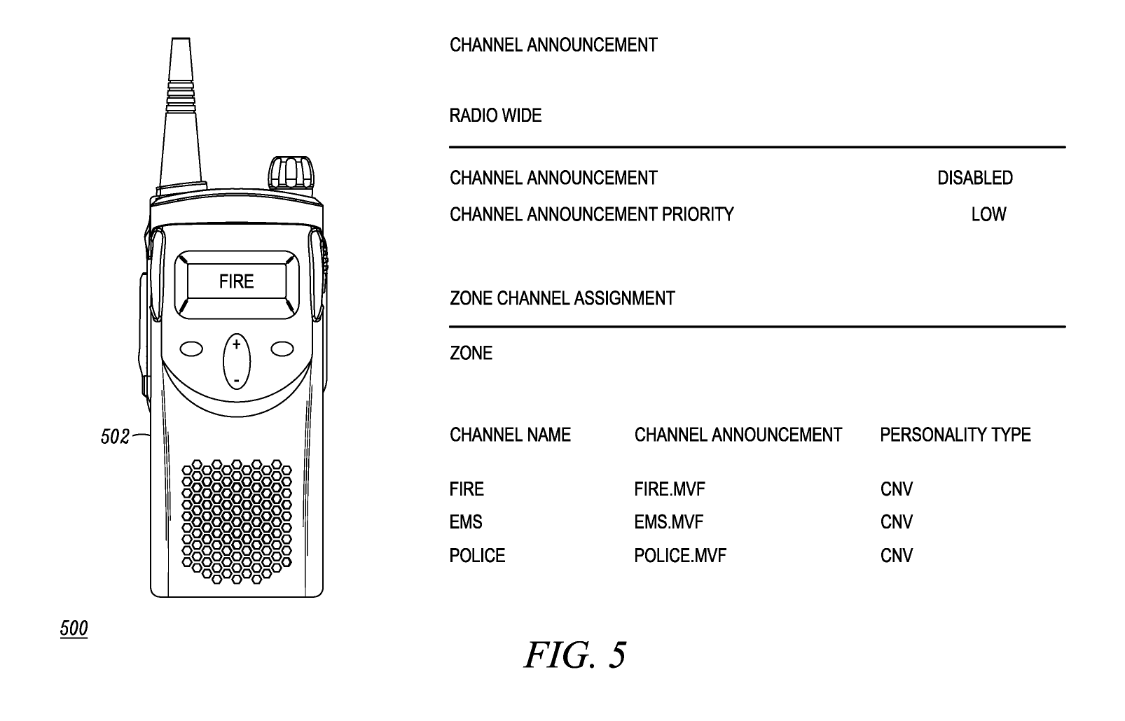

The feature report can be generated to include a summary of the feature or associated parameters and can also include the configuration settings of the parameter. The feature report is displayed on the user interface for the DPU 102. In an embodiment of the present invention, the feature report can be displayed on the display the DPU 102 whose functionalities can be configured and/or modified by the application program 104. The feature report is explained in further detail in conjunction with the FIG. 5. It should be noted that the feature report can also include other information relating to the feature and/or the feature's associated parameters.

When the customer feedback is selected by the user, testimonials and/or comments of other user's who have tried the feature can be displayed. In an embodiment of the present invention, the customer feedback can include responses to queries pertaining to the feature by other customers.

When the access feature is selected by the user, temporary access to the functions of the feature is enabled. Temporary access provides an interactive simulation allowing the user to test-drive and understand the utility of the feature prior to purchase. It should be noted that the access can be restricted for the price-based features, i.e., the price-based features may not be configured on a DPU or only accessed for a limited amount of test time. Thereafter, the method terminates at step 310. Thus, temporary access is provided for the price-based features while the free-to-use features will always be available.

FIG. 4 represents an exemplary screenshot 400 displaying the one or more features 106 of the application program 104, in accordance with an embodiment of the present invention. The screenshot 400 of the user interface for the DPU 102, includes a first window 402, a second window 404, a third window 406, and a fourth window 408. The first window 402 displays the free-to-use features 410, shown as ‘Base Features’, and the price-based features 412, shown as “Purchasable Features”. The free-to-use features 410 can be configured on the DPU 102 by a user, without any restrictions, whereas the price-based features 412 have to be purchased by the user before being configured. For example, a Global Positioning System (GPS) feature, shown to be classified in the price-based features 412 in the screenshot 400, has to be purchased before it can be configured. The screenshot 400 also shows a Channel Announcement feature 414, selected by the user, and an icon associated it.

After selecting a feature, the user can display and highlight all the fields, view a demonstration, a feature report, and/or customer feedback associated with the feature in the second window 404.

The screenshot 400 also displays the parameters associated with the feature, selected by the user, in the third window 406. For example, the third window 406 displays the parameters of the Channel Announcement feature 414. The parameters of the Channel Announcement feature 414 for a two-way radio can include for example, radio information, zone-channel announcement, scan, trunking, conventional, and radio configuration.

The screenshot 400 also displays the configuration screens in the fourth window 408. The configuration screens correspond to the parameters displayed in the third window 406. For example, a zone channel assignment configuration screen and a radio configuration screen correspond to the zone channel assignment parameter and the radio configuration parameter respectively. The zone channel assignment configuration screen allows the user to assign customized voice files to channels. The radio configuration screen allows the user to assign functions to the buttons of a two-way radio set.

FIG. 5 represents an exemplary feature report 500 of the application program 104, in accordance with one of the embodiment of the present invention. The feature report 500 shows a two-way radio 502 and its current configurations. The feature report 500 is displayed on the user interface for the DPU 102. The feature report 500 shows an example of configuration settings for the radio configuration parameter and the zone channel assignment parameter of the two-way radio 502.

FIG. 6 represents an exemplary screenshot 600 of a multimedia demonstration of the application program 104, in accordance with an embodiment of the present invention. The screenshot 600 of the user interface for the DPU 102, displays a first window 602, a second window 604, and a control 606. The first window 602 displays an example of a tree-view of parameters associated with a selected feature of the two-way radio 502. The second window 604 displays an animated procedure to assign functionalities to buttons of the two-way radio 502 through a ‘Buttons’ configuration screen. The animation can be controlled by the control 606. The control 606 can modify audio volume, jump to a forward or a backward frame of the animation, and pause and play the animation. It should be noted that the multimedia demonstration can display any other information as well.

The present invention provides a method for demonstrating one or more features to a user of a DPU. The improved user interface allows the user to interact with the features of an application program to quickly and correctly understand the feature's uses and associated functionalities. Because the user is able to test-drive the feature, less time is required to configure the features. Further, a clear understanding of the utility of the features help users select and purchase features suited to the individual's needs. Sellers also benefit from the opportunity to satisfy customers, thus increasing sales of price-based features.

It will be appreciated that the method for demonstrating one or more features to a user of a DPU, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method to enable users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thereby, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all of the claims. The invention is defined solely by the appended claims, including any amendments made during the pendency of this application, and all equivalents of those claims, as issued.

What is claimed is:

1. A method for demonstrating one or more features of an application program to a user of a data processing unit (DPU), the one or more features being associated with the application program running on the DPU, the method comprising:
displaying the one or more features, the one or more features comprising free-to-use features and price-based features;
detecting selection of at least one feature from the one or more features, the at least one feature being selected by the user;
enabling access to the at least one feature while the user is interacting with the application program; and
disabling configuration of the at least one feature when the at least one feature is a price-based feature.

2. The method as recited in claim 1 further comprising assigning at least one of an icon and a color-scheme to the at least one feature based on an input from the user, wherein the icon and the color-scheme are selected from one or more libraries.

3. The method as recited in claim 1 further comprising highlighting one or more parameters associated with the at least one feature, wherein highlighting the one or more parameters comprises providing a visual indication of the one or more parameters to the user, the visual indication being provided by using at least one of icons and color-schemes.

4. The method as recited in claim 1 further comprising displaying one or more parameters associated with the at least one feature, wherein displaying the one or more parameters comprises launching one or more configuration screens, wherein the one or more configuration screens enable configuration of the one or more parameters associated with the at least one feature.

5. The method as recited in claim 1 further comprising launching a demonstration of the at least one feature, wherein launching the demonstration comprises illustrating to the user at least one of an explanation of the at least one feature, a procedure to use the at least one feature, instructions to configure the one or more parameters, and instructions to configure the at least one feature on the DPU.

6. The method as recited in claim 5, wherein the demonstration is at least one of a video demonstration, an audio demonstration and a multimedia demonstration.

7. The method as recited in claim 1 further comprising generating a feature report of the at least one feature, wherein the feature report comprises at least one of a summary of the at least one feature, a summary of the one or more parameters, and configuration settings of the one or more parameters.

8. The method as recited in claim 1 further comprising displaying customer feedback associated with the at least one feature.

9. A method for demonstrating one or more features to a user of a data processing unit (DPU), the one or more features being associated with an application program running on the DPU, the method comprising:
displaying the one or more features;
detecting selection of at least one feature from the one or more features, the at least one feature being selected by the user; and
enabling at least one of providing a visual indication of one or more parameters associated with the at least one feature, launching one or more configuration screens to configure the one or more parameters, launching a demonstration of the at least one feature, generating a feature report of the at least one feature, displaying customer feedback associated with the at least one feature, and accessing the at least one feature while the user is interacting with the application program.

10. The method as recited in claim 9 further comprising assigning at least one of an icon and a color-scheme to the at least one feature by the user, wherein the icon and the color-scheme are selected from one or more libraries.

11. The method as recited in claim 9, wherein the one or more features include at least one of price-based features and free-to-use features.

12. The method as recited in claim 9, wherein the demonstration is at least one of a video demonstration, an audio demonstration and a multimedia demonstration.

13. The method as recited in claim 9, wherein the feature report comprises at least one of a summary of the at least one feature, a summary of the one or more parameters, and configuration settings of the one or more parameters.

14. A user interface for a data processing unit (DPU), the user interface performing the steps of:
displaying one or more features associated with an application program running on a DPU, the one or more features comprising free-to-use features and price-based features;
detecting selection of at least one feature from the one or more features, the at least one feature being selected by a user;
enabling access to the at least one feature while the user is interacting with the application program; and
disabling configuration of the at least one feature when the at least one feature is a price-based feature.

15. The user interface of claim 14 further performing the step of:
assigning at least one of an icon and a color-scheme to the at least one feature based on an input from the user, wherein the icon and the color-scheme are selected from one or more libraries.

16. The user interface of claim 14 further performing the step of:
highlighting one or more parameters associated with the at least one feature, wherein highlighting the one or more parameters comprises providing a visual indication of the one or more parameters to the user, the visual indication being provided by using at least one of icons and color-schemes.

17. The user interface of claim 14 further performing the step of:
displaying the one or more parameters associated with the at least one feature, wherein displaying the one or more parameters comprises launching one or more configuration screens, wherein the one or more configuration screens enable configuration of the one or more parameters associated with the at least one feature.

18. The user interface of claim 14 further performing the step of:
launching a demonstration of the at least one feature, wherein launching the demonstration comprises illustrating to the user at least one of an explanation of the at least one feature, a procedure to use the at least one feature, instructions to configure the one or more parameters, and instructions to configure the at least one feature on the DPU.

19. The user interface of claim 14 further performing the step of:
generating a feature report of the at least one feature, wherein the feature report comprises at least one of a summary of the at least one feature, a summary of the one or more parameters, and configuration settings of the one or more parameters.

20. The user interface of claim 14 further performing the step of:
displaying one or more customer feedbacks associated with the at least one feature.
